(19) United States
(12) Patent Application Publication
(10) Pub. No.: US 2025/0166602 A1
(43) Pub. Date: May 22, 2025

(54) SYSTEMS AND METHODS FOR SPEECH GENERATION BY EMOTIONAL VOICE CONVERSION

(71) Applicant: Datum Point Labs Inc., Jackson, WY (US)

(72) Inventors: Kyungseok Oh, Seoul (KR); Hanseok Ko, Seoul (KR); Bonhwa Ku, Seoul (KR)

(21) Appl. No.: 18/953,970

(22) Filed: Nov. 20, 2024

Related U.S. Application Data
(60) Provisional application No. 63/602,224, filed on Nov. 22, 2023.

(51) Int. Cl. G10L 13/027; G10L 13/033

(52) U.S. Cl. CPC G10L 13/027; G10L 13/033

(57) ABSTRACT

Embodiments described herein include voice conversion (VC) based Emotion Data generation. Embodiments described herein may generate a multi-speaker multi-emotion dataset by changing the gender style of the input speech while retaining its emotion style and linguistic contents. For example, a single-speaker multi-emotion dataset may be used as the input speech and a multi-speaker single emotion dataset may be the target speech. The generated data may be used as the training data for a text to speech (TTS) model so that it can generate speeches with diverse styles of emotions and speakers. To generate a multi-speaker multi-emotion dataset, embodiments herein add an emotion encoder to a VC model and use acoustic properties to preserve the emotion speech style of the input speech while changing just the gender style to the target gender style.

### TECHNICAL FIELD

The embodiments relate generally to systems and methods for speech generation.

### BACKGROUND

In machine learning, text to speech (TTS) models may generate audio speech for a given text input. Existing TTS methods can only produce voices with the styles that were used to train the TTS model. Style may include gender (e.g., male or female), and emotions (e.g., happy or surprised). A multi-speaker multi-emotion dataset may aid in training a TTS model to generate diverse styles of speech. It may be costly, however, to generate or acquire a large dataset with multiple speakers with multiple emotions sufficient to train a high-quality TTS model for multiple styles. Therefore, there is a need for improved systems and methods for speech generation.

### BRIEF DESCRIPTION OF THE DRAWINGS

FIG. 1A illustrates an exemplary framework for speech generation, according to some embodiments.

FIG. 1B is a simplified diagram of an emotion encoder 110, according to some embodiments.

FIG. 2 is a simplified diagram illustrating a computing device implementing the framework described in FIGS. 1A-1B, according to some embodiments.

FIG. 3 is a simplified block diagram of a networked system suitable for implementing the framework described in FIGS. 1A-1B and other embodiments described herein.

FIG. 4 is a simplified diagram of a style normalization and restitution (SNR) model, according to some embodiments.

FIGS. 5-6 illustrate exemplary results of embodiments described herein

### DETAILED DESCRIPTION

In machine learning, text to speech (TTS) models may generate audio speech for a given text input. Existing TTS methods can only produce voices with the styles that were used to train the TTS model. Style may include gender (e.g., male or female), and emotions (e.g., happy or surprised). A multi-speaker multi-emotion dataset may aid in training a TTS model to generate diverse styles of speech. It may be costly, however, to generate or acquire a large dataset with multiple speakers with multiple emotions sufficient to train a high-quality TTS model for multiple styles.

The styles of the speeches generated by an adaptive TTS may be dependent on the styles in the training data. To express diverse styles on adaptive TTS, it needs to learn at least various types of styles which may include gender voices in diverse emotional states.

Embodiments described herein include voice conversion (VC) based Emotion Data generation. VC is a technique to change the style of the input speech to a target style while preserving the linguistic contents of the input speech. Embodiments described herein may be used to generate a multi-speaker multi-emotion dataset by changing the gender style of the input speech while retaining its emotion style and linguistic contents. For example, a single-speaker multi-emotion dataset may be used as the input speech and a multi-speaker single emotion dataset may be the target speech. The generated data may be used as the training data for a TTS so that it can generate speeches with diverse styles of emotions and speakers. To generate a multi-speaker multi-emotion dataset, embodiments herein add an emotion encoder to a VC model and use acoustic properties to preserve the emotion speech style of the input speech while changing just the gender style to the target gender style.

Embodiments described herein provide a number of benefits. For example, embodiments described herein may generate a multi-speaker multi-emotion dataset using a single gender speaker multi-emotion dataset and a multi-speaker neutral emotion dataset. Other methods use public multi-speaker and multi-emotion datasets but the amount of data produced with insufficient number of speakers is not enough to guarantee the quality, emotional expression and the style of the adaptive TTS. Embodiments described herein solve the lack of emotional data by converting between datasets with different characteristics instead of converting within one emotion dataset. Additionally, it is possible to estimate the emotional expression of gender styles that were not in the training process by using only the emotional data from a single gender speaker, showing the superiority of this technique compared to existing methods.

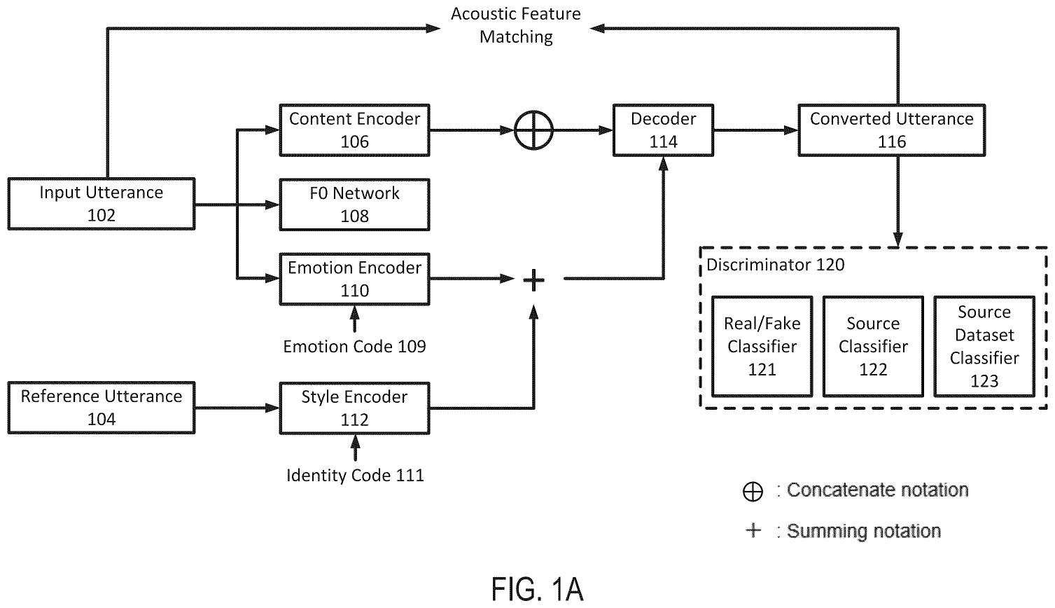

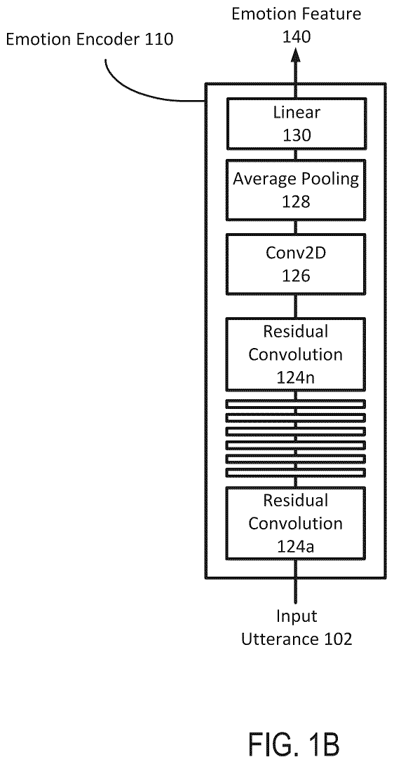

FIG. 1A illustrates an exemplary framework for speech generation, according to some embodiments. The framework of FIG. 1A generates multi-speaker multi-emotional data using voice conversion (VC). VC is a technique to convert the gender style of the input speech to the gender style of the target speech. In some embodiments, a single-speaker multi-emotion dataset is used as input speech and a multi-speaker neutral emotion dataset is the target speech. To generate emotion data based on two datasets with different domains, embodiments described herein retain the emotion style of the input speech and convert only the gender style to the target speech.

The emotion style of the speech generated through VC may be generated to be the same style as the input speech. To this end, the framework trains the VC model to generate outputs that have one or more of four acoustic features described below matching the features of the input speech. First, a spectral centroid may be matched. A spectral centroid is the position of the center of mass of the spectrum. A high value indicates emotions such as excitement or anger, and low values indicate sad emotions. Second, spectral kurtosis may be matched. Spectral kurtosis shows the existence of increased energy concentration within specific frequency ranges. Spectral kurtosis can detect subtle changes in intonations, such as surprise. Third, loudness may be matched. Additional information about energy or voice-related, typically prosodic and indicative of arousal. Fourth, a change in F0 may be matched. The change in F0 capture change in intonation. A considerable change implies strong emotions such as anger and excitement. A loss objective may be computed comparing these features between the input utterance and the converted utterance, so that the model may learn to match these features in generating an output utterance.

As illustrated in FIG. 1A, an input utterance 102 may be input to a content encoder 106, a F0 network 108, and/or an emotion encoder 110. Emotion encoder 110 may also receive an emotion code 109. Outputs of the content encoder 106 and F0 network 108 may be concatenated and input to a decoder 114. A reference utterance 104 (e.g., a neutral utterance audio) may be input to a style encoder 112 together with an identity code 111. The output of emotion encoder 110 may be summed with the output of style encoder 112 and input to decoder 114. Decoder 114 may generate, based on the described inputs, the converted utterance audio 116. The converted utterance audio 116 may be input to a discriminator 120 which is trained jointly with one or more of the components of FIG. 1A. Discriminator 120 may include a real/fake classifier 121, a source classifier 122, and/or a source dataset classifier 123. The discriminator may be used to compute an additional or alternative loss objective used to train components of FIG. 1A.

In some embodiments, voice conversion may be performed between different datasets to synthesize emotion data. The differences in the distribution of the different datasets generate unwanted noise in the generated speech. The source dataset classifier (SDC) 123 addresses this. SDC 123 improves the sound quality and reduces noise by having the VC model trained so that the generated speech's distribution can include both the distribution of generated speeches and the target speeches. In some embodiments, the proposed method to use VC to generate emotion data requires emotion style from the input speech and the gender style from the target speech. Style encoder 112 extracts styles that include both gender and emotion styles, so it is impossible to retain the emotion style of the input speech with style encoder 112 module alone. In some embodiments, emotion encoder 110 is also included in order to obtain the emotion style from the input speech, as described in FIG. 1B.

FIG. 1B is a simplified diagram of an emotion encoder 110 (e.g., the emotion encoder 110 of FIG. 1A), according to some embodiments. Emotion Encoder 110 allows the framework in FIG. 1A to obtain the emotion style from the input speech 102. Together with a matching loss, the separation of the emotion style and gender style may be induced by obtaining just the emotion style from emotion encoder 110, and only the gender style from style encoder 112. As illustrated, emotion encoder 110 may receive an input utterance 102 and generate an emotion feature 140. The input utterance 102 may be modified by a sequence of different layers including residual convolution layers 124a-124n. There may be, for example, four residual convolution layers 124. Emotion encoder 110 may further include a conv2D 126, average pooling 128, and linear output layer 130 as illustrated.

An ideal emotion encoder 110 extracts only features related to the emotion style without extracting gender, etc. Emotion encoder 110 may be pre-trained. Before learning the VC model, pre-training may be performed to classify emotions by entering data from a a multi-speaker multi-emotional dataset into the emotion encoder 110. The pre-trained emotion encoder 110 derives the same classification result if the emotions are the same even if the gender styles of the input voices are different. If the VC model uses pre-trained weights of the emotion encoder 110, the emotion encoder 110 is expected to extract emotional style features that exclude the gender style of the input voice. This may improve the gender similarity of the generated voice.

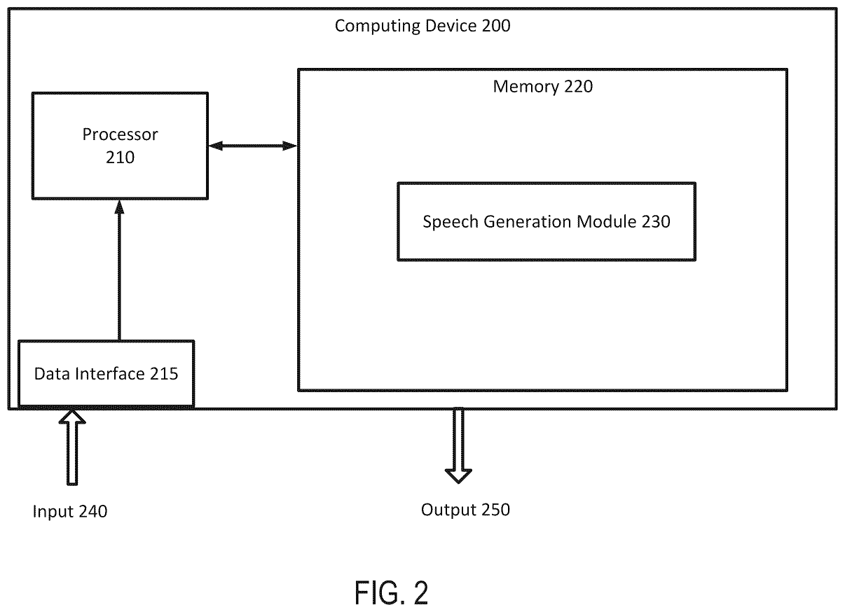

FIG. 2 is a simplified diagram illustrating a computing device 200 implementing the framework described in FIGS. 1A-1D, according to some embodiments. As shown in FIG. 2, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for speech generation module 230 that may be used to implement and/or emulate the systems and models, and/or to implement any of the methods described further herein. Speech generation module 230 may receive input 240 such as an input utterance, a reference utterance, emotion code, identity code, and/or text input, etc. and generate an output 250 which may be a generated speech audio.

The data interface 215 may comprise a communication interface, a user interface (such as a voice or text input interface, a graphical user interface, and/or the like). For example, the computing device 200 may receive the input 240 from a networked device via a communication interface. Or the computing device 200 may receive the input 240 from a user via the user interface.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

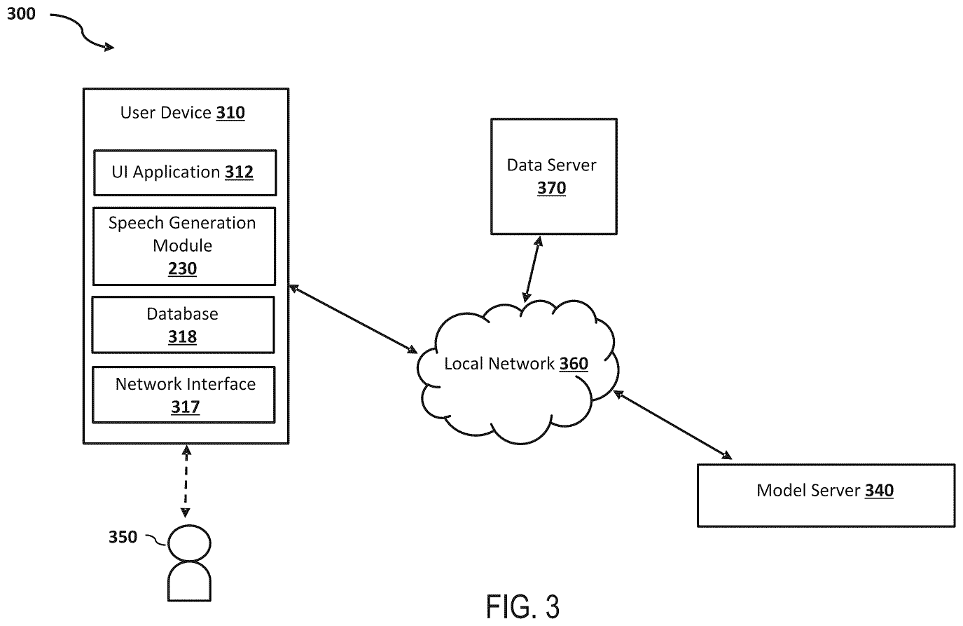

FIG. 3 is a simplified block diagram of a networked system 300 suitable for implementing the framework described in FIGS. 1A-1B and other embodiments described herein. In one embodiment, system 300 includes the user device 310 (e.g., computing device 200) which may be operated by user 350, data server 370, model server 340, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

User device 310, data server 370, and model server 340 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over local network 360.

In some embodiments, all or a subset of the actions described herein may be performed solely by user device 310. In some embodiments, all or a subset of the actions described herein may be performed in a distributed fashion by various network devices, for example as described herein.

User device 310 may be implemented as a communication device that may utilize appropriate hardware and software configured for wired and/or wireless communication with data server 370 and/or the model server 340. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312, and speech generation module 230, which may correspond to executable processes, procedures, and/or applications with associated hardware. For example, the user device 310 may allow a user to input text for TTS, or otherwise interact with a system which automatically generates text (e.g., a chat agent). In other embodiments, user device 310 may include additional or different modules having specialized hardware and/or software as required.

In various embodiments, user device 310 includes other applications as may be desired in particular embodiments to provide features to user device 310. For example, other applications may include security applications for implementing client-side security features, programmatic client applications for interfacing with appropriate application programming interfaces (APIs) over local network 360, or other types of applications. Other applications may also include communication applications, such as email, texting, voice, social networking, and IM applications that allow a user to send and receive emails, calls, texts, and other notifications through local network 360.

Local network 360 may be a network which is internal to an organization, such that information may be contained within secure boundaries. In some embodiments, local network 360 may be a wide area network such as the internet. In some embodiments, local network 360 may be comprised of direct connections between the devices. In some embodiments, local network 360 may represent communication between different portions of a single device (e.g., a network bus on a motherboard of a computation device).

Local network 360 may be implemented as a single network or a combination of multiple networks. For example, in various embodiments, local network 360 may include the Internet or one or more intranets, landline networks, wireless networks, and/or other appropriate types of networks. Thus, local network 360 may correspond to small scale communication networks, such as a private or local area network, or a larger scale network, such as a wide area network or the Internet, accessible by the various components of system 300.

User device 310 may further include database 318 stored in a transitory and/or non-transitory memory of user device 310, which may store various applications and data (e.g., model parameters, audio data, etc.) and be utilized during execution of various modules of user device 310. Database 318 may store text, audio, style preferences, etc. In some embodiments, database 318 may be local to user device 310. However, in other embodiments, database 318 may be external to user device 310 and accessible by user device 310, including cloud storage systems and/or databases that are accessible over local network 360.

User device 310 may include at least one network interface component 317 adapted to communicate with data server 370 and/or model server 340. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data Server 370 may perform some of the functions described herein. For example, data server 370 may store a training dataset including text, audio, style parameters, etc.

Model server 340 may be a server that hosts models such as a pre-trained TTS model, a discriminator model, and/or other models described in FIGS. 1A-1B. Model server 340 may provide an interface via local network 360 such that user device 310 may perform functions relating to the models as described herein (e.g., generating speech). Model server 340 may communicate outputs of models via local network 360.

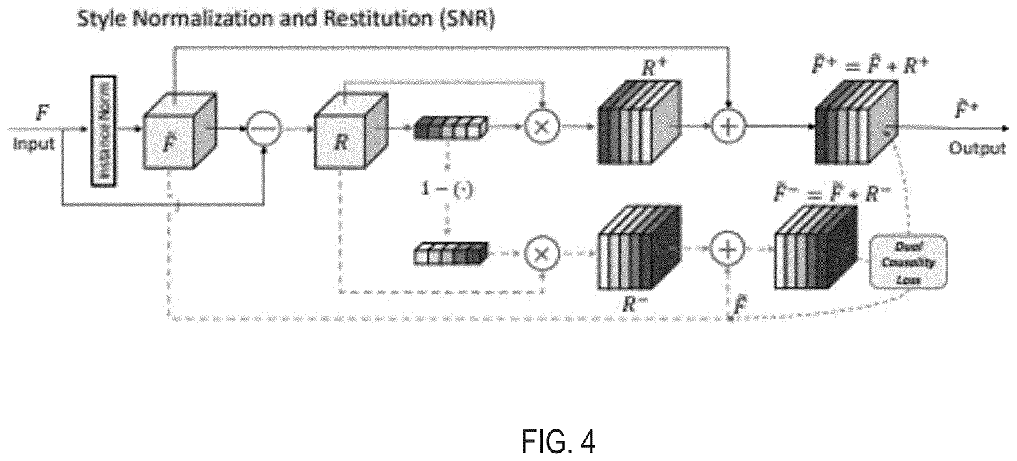

FIG. 4 is a simplified diagram of a style normalization and restitution (SNR) model, according to some embodiments. The separation of emotion and gender styles is a factor in determining the quality of the generated emotion data. In some embodiments, only emotion style must be extracted from the input speech and only the gender style must be extracted from the target speech. Further improvements may be realized, increasing gender similarity. This can be interpreted as the emotion encoder extracting emotion styles features containing the gender style. Improved performance may be achieved, in some embodiments, through an additional method to separate emotion and gender styles as follows.

A style normalization and restitution (SNR) module may be used for separation of gender and emotion style. The SNR module is a method used in the field of human re-identification that divides human features into features related to style and not related. FIG. 4 shows the structure of an exemplary SNR module. Through the proposed model structure and loss, the two features resulted in strengthening the style-related feature \tilde{F}⁺ and weakening the unrelated feature \tilde{F}⁻, leading to separation from each other. One objective is to separate one style from gender style and emotion style. By applying the structure of the SNR module to the style encoder 112, the characteristics of \tilde{F}⁺ are used as a gender style, and \tilde{F}⁻ is intended to be used as an emotional style. This method improves both the gender similarity and emotional similarity of the generated speech.

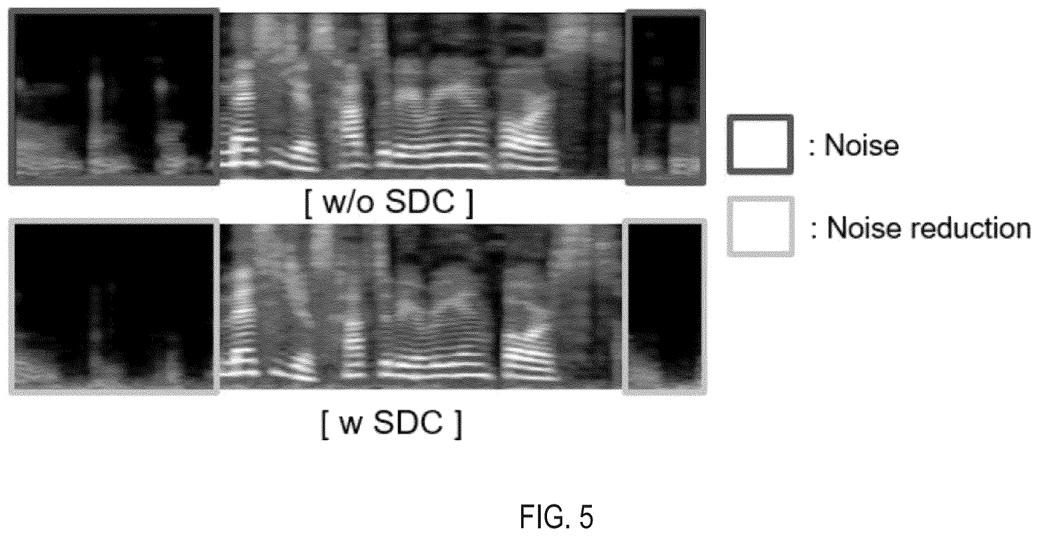

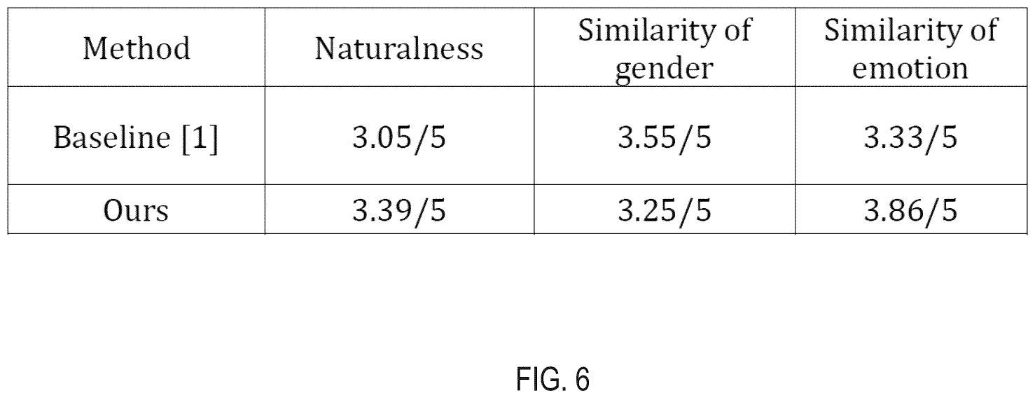

FIGS. 5-6 illustrate exemplary results of embodiments described herein.

FIG. 5 illustrates experimental results based on the use of SDC, showing reduced noise with the use of SDC.

FIG. 6 illustrates mean opinion score (MOS) results of voice conversion (VC).

To verify the performance of the method described herein, an emotion dataset was used as the input speech and the VCTK dataset as the target speech. The dataset consists of one female speaker and multiple emotion data. The experiment only used neutral, happiness, surprise, anger, and sadness among many emotions. The VCTK dataset consists of the speech data of 109 speakers with only neutral emotion. For the experiment, 60 speakers were selected out of the 109 speakers. This means that an experiment was performed to augment a single speaker multi-emotion dataset to a 60 speaker multi-emotion dataset. The performance of the generated multi-speaker multi-emotion dataset was evaluated by Mean Opinion Score (MOS). MOS is an evaluation method where humans directly listen to the generated speeches and select a score from 1 to 5 points for evaluation. Higher scores indicate better performance. The following three evaluation criteria for evaluation were set. The performance comparison was conducted between the proposed method and a baseline model.
1. Naturalness: indicator of the quality of the generated speech
2. Gender similarity: indicator of the similarity of the gender styles of the generated speech and the target speech
3. Emotion similarity: indicator of similarity of the emotion styles of the generated speech and the input speech.

The method described herein showed a drop in the gender style similarity but improved results in sound quality and emotion style similarity. These results show that it is possible to generate multi-speaker multi-emotion dataset with the method described herein.
a multi-speaker multi-emotion dataset may be generated using a single female speaker multi-emotion dataset as the input to the VC model. In this process, the emotion data for the female exist, but the emotion data for males don't exist. Men and women have different bands of sound frequencies. It is difficult to generate male emotional expressions based on a female's emotion. To address this, additional male emotion data may be used. male emotion data may be further utilized from ESD data to address this. The ESD dataset consists of 10 male and 10 female speakers and each speaker has five emotions (neutral, happy, sad, surprise and angry). this problem may be resolved by involving some male speakers in the VC learning process.

The devices described above may be implemented by one or more hardware components, software components, and/or a combination of the hardware components and the software components. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of the processing element. For example, the processing device may include a plurality of processors or include one processor and one controller. Further, another processing configuration such as a parallel processor may be implemented.

The software may include a computer program, a code, an instruction, or a combination of one or more of them, which configure the processing device to be operated as desired or independently or collectively command the processing device. The software and/or data may be interpreted by a processing device or embodied in any tangible machines, components, physical devices, computer storage media, or devices to provide an instruction or data to the processing device. The software may be distributed on a computer system connected through a network to be stored or executed in a distributed manner The software and data may be stored in one or more computer readable recording media.

The method according to the exemplary embodiment may be implemented as a program instruction which may be executed by various computers to be recorded in a computer readable medium. At this time, the medium may continuously store a computer executable program or temporarily store it to execute or download the program. Further, the medium may be various recording means or storage means to which a single or a plurality of hardware is coupled and the medium is not limited to a medium which is directly connected to any computer system, but may be distributed on the network. Examples of the medium may include magnetic media such as hard disk, floppy disks and magnetic tapes, optical media such as CD—ROMs and DVDs, magneto—optical media such as optical disks, and ROMs, RAMS, and flash memories to be specifically configured to store program instructions. Further, an example of another medium may include a recording medium or a storage medium which is managed by an app store which distributes application, a site and servers which supply or distribute various software, or the like.

Although the exemplary embodiments have been described above by a limited embodiment and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved. It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method of speech generation, comprising:
generating, via an emotion encoder, an emotion feature based on an input audio including a first utterance;
generating, via a style encoder, and encoded style based on a reference audio including a second utterance;
generating, via a decoder, a converted audio utterance based on the emotion feature and the encoded style;
computing a loss function based on at least one of:
acoustic feature matching of the input audio to the converted audio utterance; or
a source dataset classification from a source dataset classifier; and
training at least one of the emotion encoder or the style encoder based on the loss function.
